(19) United States
(12) Patent Application Publication
(10) Pub. No.: US 2007/0121426 A1
(43) Pub. Date: May 31, 2007

(54) 24-hour watch or clock

(76) Inventors: Rouben A. Simonian, Auburn, AL (US); Armen Simonian, Moscow (RU); Aleksandr L. Simonian, Auburn, AL (US)

Correspondence Address: BROWDY AND NEIMARK, P.L.L.C.;624 NINTH STREET, NW, SUITE 300, WASHINGTON, DC, 20001-5303, US

(21) Appl. No.: 11/288,213

(22) Filed: Nov. 29, 2005

(51) Int. Cl. G04F 3/00

(52) U.S. Cl. 368/100

(57) ABSTRACT

A watch or clock has a face which is divided along its outer perimeter into 24 one-hour increments. The face is divided along an inner perimeter into incremental indicators for portions of each hour. The watch hands are reversed relative to conventional watch or clock faces, with the length of the hour hand exceeding the length of the minute hand.

### FIELD OF THE INVENTION

The present invention relates to a watch or clock and method of telling time therewith. Specifically, the watch or clock comprises a novel face divided along its outer perimeter into 24 one-hour increments. It is divided along an inner perimeter into incremental indicators for portions of each hour (e.g., quarter-hour markers). Importantly, the watch hands are reversed relative to conventional watch or clock faces, with the length of the hour hand exceeding that of the minute hand.

### BACKGROUND OF THE INVENTION

Several watch or clock designs currently exist for 24-hour timekeeping. Some utilize a traditional clock face, but provide additional indicators to the user in order to designate morning or evening. For example, Schenk et al, in U.S. Pat. No. 6,359,839, disclose a watch with a 24-hour watch face that retains the conventional 12-hour analog display of conventional watches, but includes two distinguishable signals (e.g., sun and moon) to clearly indicate the time of day. U.S. Pat. No. 6,614,727 to McGuire provides for a children's clock housing a traditional clock face and a moveable, three-dimensional display. Depending upon the time of day, one of two or more scenes is openly displayed, the others remaining hidden within the clock housing.

Swiss watchmaker Rolex produces an Oyster Perpetual Explorer II™ with a traditional, 12-hour analog face, encircled by a metal frame divided into 24-hour increments.

Still other prior art provides a departure from traditional clock or watch faces. Chaut, in U.S. Pat. Nos. 5,602,803; 5,671,194; 5,844,864; and 5,999,496, provides for various novel clock faces. The essential design comprises a support frame and a driven gear with external teeth mounted to the support frame. The device further includes a rigid annular member having internal teeth that engage the external teeth of the driven gear. However, all of the Chaut designs appear to utilize the conventional, 12-hour increments that characterize traditional watch or clock faces.

### SUMMARY OF THE INVENTION

Thus, it is an object of the present invention to provide a 24-hour watch or clock with a novel face and hands, and a method of telling time using said watch or clock.

It is a further object of the invention to provide a watch that utilizes a novel means of dividing the watch face into hourly increments, namely, into 24 increments rather than twelve.

It is a still further object of the present invention to provide a watch with a face that includes along its outer perimeter 24, one hour increments, and, along an inner perimeter, indicators delineating fractions of an hour (e.g., quarter-hour increments).

It is a still further object of the invention to provide a novel configuration of watch hands to correspond with the novel design of the 24-hour watch or clock face. Specifically, the length of the hour hand exceeds that of the minute hand.

The scope and content of the present invention is not intended to be limited by or to the above mentioned objects.

One embodiment of the 24 hour watch or clock comprises a watch face with numbers 1-24, each number corresponding to an hour of the day, disposed about the outer perimeter of the watch or clock face. Alternatively, other markings, symbols, or the like may be used to designate each hour of the day.

In another embodiment of the 24-hour watch or clock, numbers are evenly spaced about the outer perimeter. One example is numbers or figures disposed at 90° angles from each other beginning at the top.

The watch or clock face also includes numbers (or other symbols or markings) distributed around a smaller, inner perimeter of the face. In one embodiment, the watch face includes markers for each minute, with numbers designating quarter-hour increments (i.e., 15, 39, 45, and 60), each number disposed at a 90 degree angle from its predecessor and successor. A long, hour hand rotates around the watch face to mark the passage of the hours, while a shorter minute hand indicates the passage of each minute.

### BRIEF DESCRIPTION OF THE DRAWINGS

FIGS. 1-4 provide frontal views of various face designs for the proposed 24-hour watch or clock.

FIG. 5 depicts the 24-hour watch face as part of a watch.

FIG. 6 is a frontal view of the 24-hour clock face as part of an alarm clock.

FIG. 7 provides a frontal view of the 24-hour clock face as part of a grandfather clock.

### DETAILED DESCRIPTION OF THE INVENTION

The invention will be described in general with reference to the Figures, which illustrate several possible embodiments of the 24-hour watch or clock. A method of telling time using the watch or clock will also be provided.

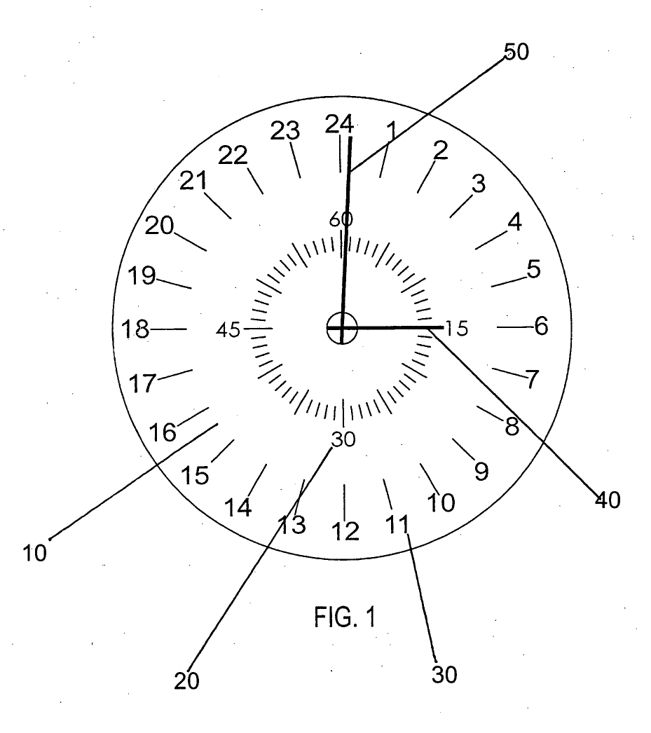

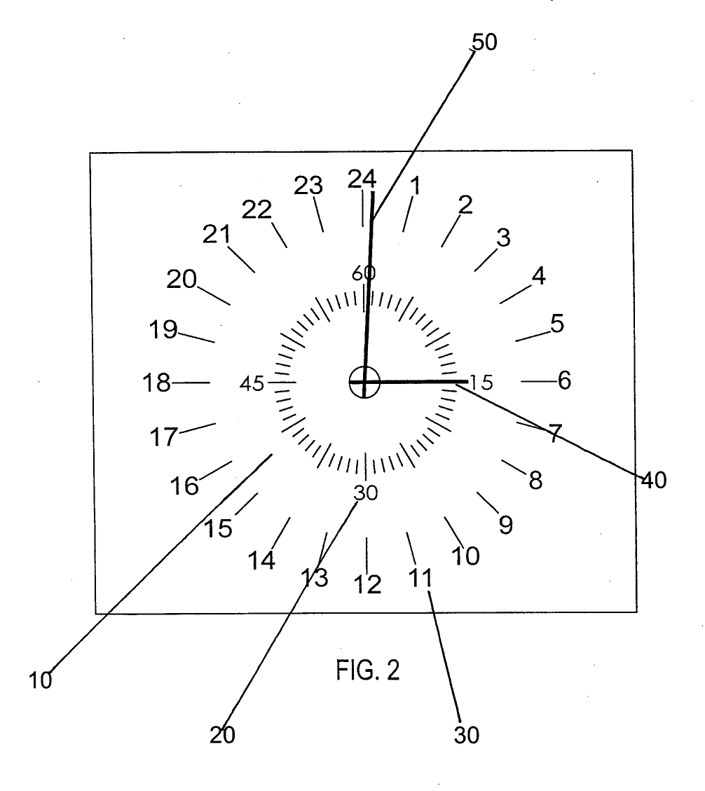

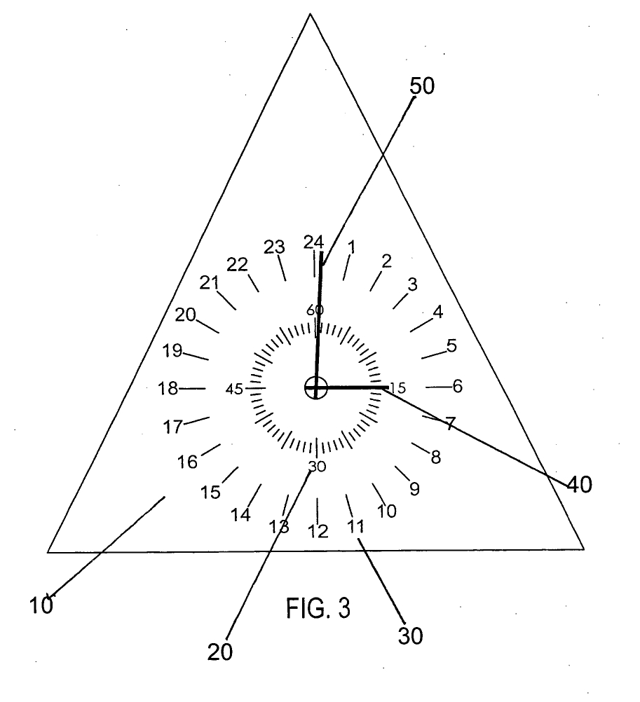

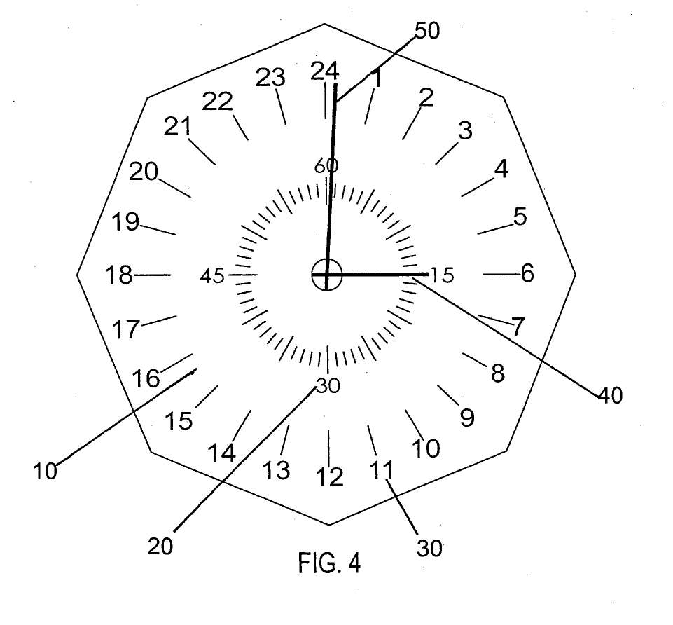

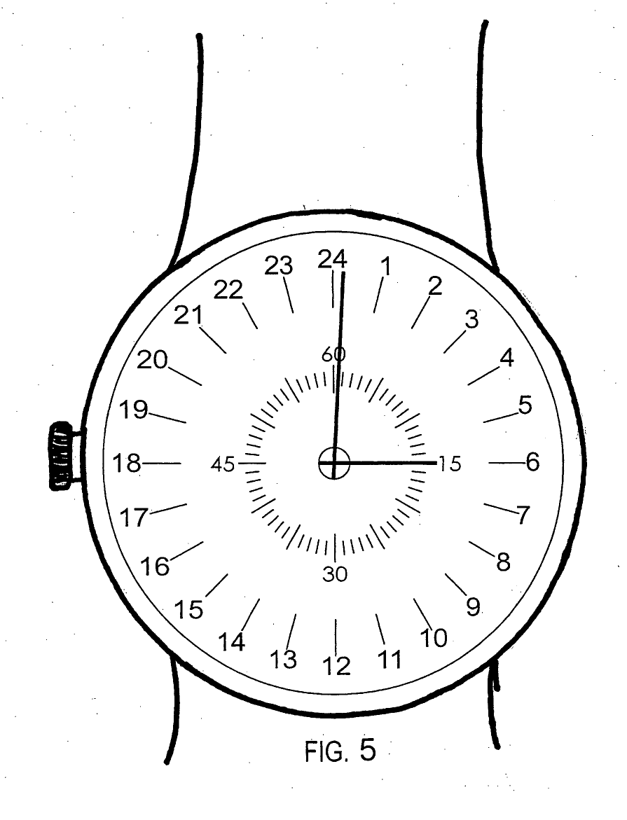

Referring to FIGS. 1-4, the 24-hour watch or clock comprises a watch face 10 with an analog display comprising a set of 24 numerals 30, one for each hour of the day, disposed along an outer perimeter of said watch or clock face 10. However, other markers, symbols, or the like may be used in lieu of numerals to mark the 24-hour increments along the perimeter of the face.

Alternatively, there are markers for more than one-hour increments along the perimeter of the face. These may be in the 2, 4, 6 or 12-hour increments, adding up to a total of 24 hours around the periphery.

The watch or clock face 10 also includes a set of numerals (or other symbols or markers) 20, corresponding to increments of each hour, disposed along a smaller, inner perimeter of the face 10. Although the Figures mark off quarter-hour increments, it should be noted that the incremental markings may correspond to any fraction of an hour, such as every 10 minutes or every five minutes.

A long, hour hand 50, corresponding to the 24 numerals or markings along the outer perimeter of the watch or clock face 10, rotates around the watch face, marking the passage of each hour. A shorter minute hand 40, corresponding to the numerals or markings along the inner perimeter of the face 10, indicates the passage of each minute.

The frame of the watch or clock typically houses a mechanism for driving the hour hand 50 and minute hand 40. Any conventional horological mechanism may be used to turn the hour and minute hands.

The hour hand 50 rotates around the face 10 of the clock or watch once every 24 hours. The minute hand 40 rotates about the face 10 of the watch once every sixty minutes.

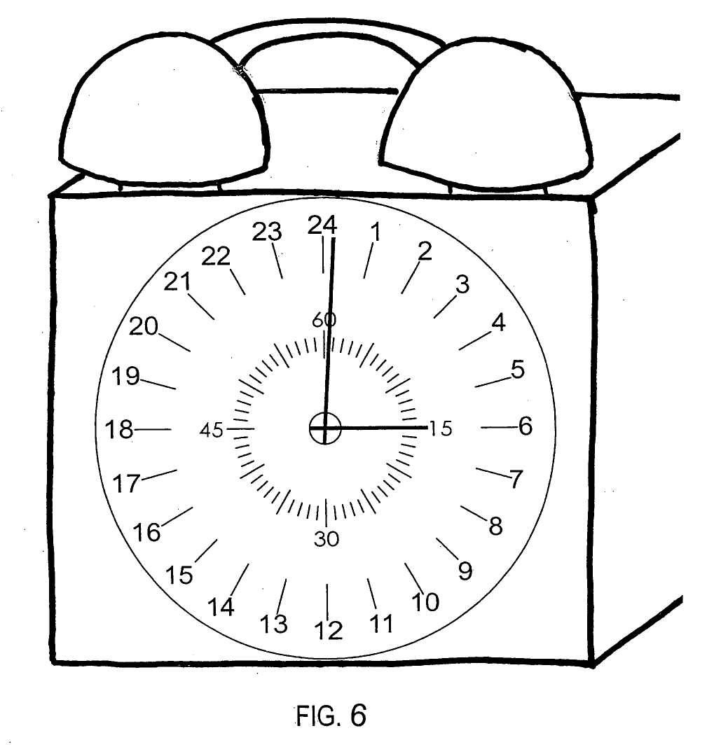

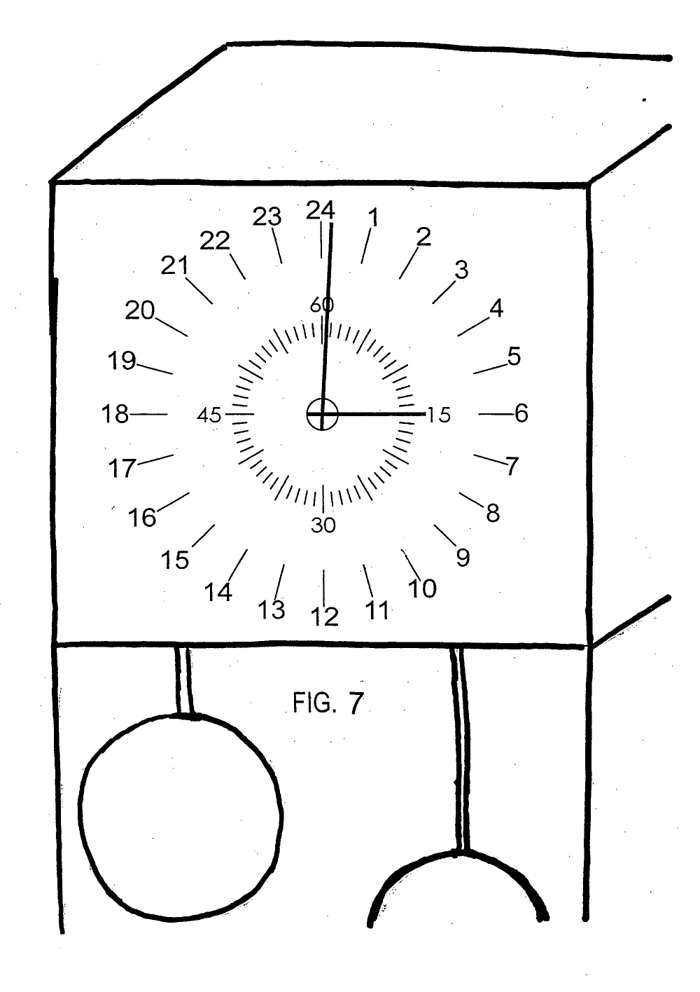

The face 10 of the watch or clock can be manufactured in any convenient shape over which the 24-hour and sixty minute intervals can be arranged. Nonlimiting examples of such configurations are shown in FIGS. 1-4, and include circles, squares, triangles, and octagons. Indeed, any polygonal shape is adaptable to the design of the 24-hour watch or clock. Further, the watch or clock may have additional accessories, embellishments, or functions. FIG. 6, for example, depicts the use of the 24-hour face 10 as part of an alarm clock. FIG. 7 shows the 24-hour face 10 as part of a grandfather clock. Additionally, the watch or clock may be enhanced with various gems, colors, or the like to appeal to a wide variety of consumer tastes.

It is to be understood that the phraseology or terminology employed herein is for the purpose of description and not of limitation. The means and materials for carrying out various disclosed functions may take a variety of alternative forms without departing from the invention.

Thus, the expressions “means to . . . ” and “means for . . . ” as may be found in the specification above and/or in the claims below, followed by a functional statement, are intended to define and cover whatever structural, physical, chemical, or electrical element or structures which may now or in the future exist for carrying out the recited function, whether or not precisely equivalent to the embodiment or embodiments disclosed in the specification above. It is intended that such expressions be given their broadest interpretation.

1. A watch or clock comprising an analog 24-hour display, wherein the face of said watch or clock comprises:
a. an analog display comprising a set of numerals, symbols, or markings, one for each hour of the day or for each fraction of 24 hours of the day, disposed along an outer perimeter of the watch or clock face;
b. a set of numerals, symbols, or markers corresponding to fractions of an hour disposed along an inner perimeter of said watch or clock face;
c. an hour hand which rotates around the watch or clock face once in a 24-hour period;
d. a minute hand which rotates around the watch or clock face once an hour; and wherein
e. the hour hand is longer than the minute hand.

2. A watch or clock face according to claim 1 wherein the face is configured in a polygonal shape.

3. A watch or clock face according to claim 2 wherein the face is configured in a circle.

4. A watch or clock face according to claim 2 wherein the face is configured in a square.

5. A watch or clock face according to claim 2 wherein the face is configured in a triangle.

6. A watch or clock face according to claim 2 wherein the face is configured in an octagon.

7. A watch or clock according to claim 1 wherein said face is part of an alarm clock.

8. A watch or clock according to claim 1 wherein the face is part of a grandfather clock.

9. The watch or clock according to claim 1 wherein the set of numerals corresponding to fractions of an hour correspond to one-quarter hour fractions.

10. The watch or clock according to claim 1 wherein the 24-hour increments of each day are designated by the numerals 1-24.

11. The watch or clock according to claim 1 wherein the 24-hour increments of each day are designated by symbols other than numbers.
